(19) United States
(12) Patent Application Publication
(10) Pub. No.: US 2016/0376489 A1
(43) Pub. Date: Dec. 29, 2016

(54) LUBRICANT FOR HIGH pH WATER BASED MUD SYSTEM

(71) Applicant: Halliburton Energy Services, Inc., Houston, TX (US)

(72) Inventor: Kenneth W. Pober, Houston, TX (US)

(21) Appl. No.: 15/038,811

(22) PCT Filed: Dec. 29, 2013
(86) PCT No.: PCT/US2013/078175

§ 371 Date: May 24, 2016

(51) Int. Cl. C09K 8/035; E21B 21/00

(52) U.S. Cl. CPC C09K 8/035; E21B 21/00; C09K 2208/34; C09K 2208/12; C09K 2208/20

(57) ABSTRACT

A method of drilling a wellbore in a subterranean formation employing a high pH aqueous mud or drilling fluid with a high pH lubricant. In one embodiment, the lubricant, which significantly improves the lubricity of the fluid in a high pH environment, comprises about 80 volume percent 2-octyldodecanol and about 20 volume percent alkylglucoside. In one embodiment, the alkylglucoside is comprised of 2-ethylhexylglucoside or a mixture of alkylglucosides having more than about 10 carbon atoms in the alkyl chain. The lubricant is effective at pH ranges from 7 to 14, preventing the lubricity of the aqueous drilling fluid from declining in relation to increasing pH.

### BACKGROUND

1. Technical Field

This disclosure is related to drilling wellbores in subterranean formations and to methods and compositions for lubricating drilling apparatus used to accomplish such drilling. Particularly, this disclosure relates to drilling fluids or muds and more particularly to lubricants for high pH muds.

2. Description of Relevant Art

Rotary drilling methods employing a drill bit and drill stems have long been used to drill wellbores in subterranean formations. Drilling fluids or muds are commonly circulated in the well during such drilling to cool and lubricate the drilling apparatus, lift cuttings out of the wellbore, and counterbalance the subterranean formation pressure encountered. An important function of drilling fluid is to reduce the considerable torque on the rotating drill stem caused by the friction between the outside of the drill pipe comprising the drill stem and the wall of the well and/or casing strings. Drilling through offsets and highly deviated or horizontal wells results in increased frictional forces, increasing the demand on the lubricating properties of the drilling fluids.

The lubrication characteristics of drilling fluids have been studied and a number of patents disclose lubrication additives or lubricants for oil based drilling fluids and aqueous based drilling fluids. Oil based fluids, and additives for such fluids, tend to be more costly to use than aqueous based fluids, and consequently, aqueous based fluids are more often preferred. However, aqueous based fluids tend to have more lubricity problems and potentially adverse effects on the subterranean formation, such as causing swelling of clays, than encountered with oil based fluids. Silicate drilling fluids, or more specifically, aqueous based fluids containing silicate additives, have long been known to inhibit formation damage caused by water but have also long been known to have poor lubricity properties. Lubricants commonly known and typically used in water based muds do not provide good lubricity in silicate muds.

Silicic acid based drilling fluids have been found to have advantageous inhibitive effects similar to silicate drilling fluids and moreover have been found to also provide a membrane-efficient water-based mud. See U.S. Pat. No. 6,997,270, of Fersheed K. Mody, Kenneth W. Pober (also inventor of the present disclosure), and others, issued Feb. 14, 2006. However, silicic acid based drilling fluids have tended to have high torque and drag values, and traditional mud lubricants have typically shown little to no effect in a silicic acid mud.

The inventor of the present disclosure and others discovered a lubricant reported in U.S. Pat. No. 6,989,352, issued Jan. 24, 2006, that is effective in silicic acid muds. With increasing use of horizontal drilling practices, however, and increased demands on lubricants for drilling fluids, there has remained an interest in further aqueous drilling fluids and mud systems with improved lubricity and for lubricants for such muds.

With environmental compatibility and biodegradability in mind, modified triglycerides have been found to be effective lubricants in conventional water based drilling fluids. Various products based on esters including vegetable oils or oils of other natural origin which have been chemically modified to allow them to be water dispersible or soluble, have been used in aqueous based muds to reduce torque and drag and reduce wear arising from steel to steel friction particularly when drilling highly deviated and extended reach wells. These products have also been found to have environmental advantages in that they are readily biodegradable. However, these lubricants quickly hydrolyze and lose effectiveness in aqueous based muds with high pH and/or high temperature. Byproducts of such hydrolysis, such as soaps, also adversely affect the other properties of the muds. These lubricants are also themselves adversely affected by alkaline contaminants in muds such as cement.

Nevertheless, the National Association of Corrosion Engineers has recommended a pH of 10 or higher for drilling muds to neutralize hydrogen sulfide in the drilling environment in a subterranean formation. The service life of steel equipment used in drilling is directly related to the concentration of hydrogen sulfide in the drilling environment and the equipment's exposure to it. Maintaining an alkaline pH will significantly reduce equipment failures due to hydrogen sulfide corrosion of the equipment.

A high pH is also conducive to the effectiveness of dispersants, which are commonly used in drilling fluids to maintain pumpability of the fluid. Dispersants promote deflocculation or reduced clumping of clay particles in the fluid during drilling. However, many or most dispersants require a high pH to work, preferably as high as about 11 although some dispersants will work at a pH of about 9.5.

Thus drilling fluid systems and additives such as lubricants that are functional at a high pH continue to be desired.

### BRIEF DESCRIPTION OF DRAWINGS

FIG. 1 is a graph illustrating the lubricity coefficient of an aqueous brine solution as a function of pH, showing a rapid increase of the lubricity coefficient with an increase in pH.

FIG. 2 is a diagram of a typical drilling fluid system in which the drilling fluids of the disclosure may be used.

### DETAILED DESCRIPTION OF PREFERRED EMBODIMENTS

The present disclosure provides a mud lubricant for aqueous drilling fluids, and an aqueous drilling fluid comprising such lubricant, for use in drilling wellbores in subterranean formations. The disclosure further comprises a method of drilling a wellbore in a subterranean formation using drilling fluids comprising the mud lubricant of this disclosure. The disclosure is particularly suited for use in drilling wellbores in hydrocarbon bearing subterranean formations. Significantly, the mud lubricant of the disclosure is functional at a high pH and the drilling fluid in which this lubricant is used has a high pH.

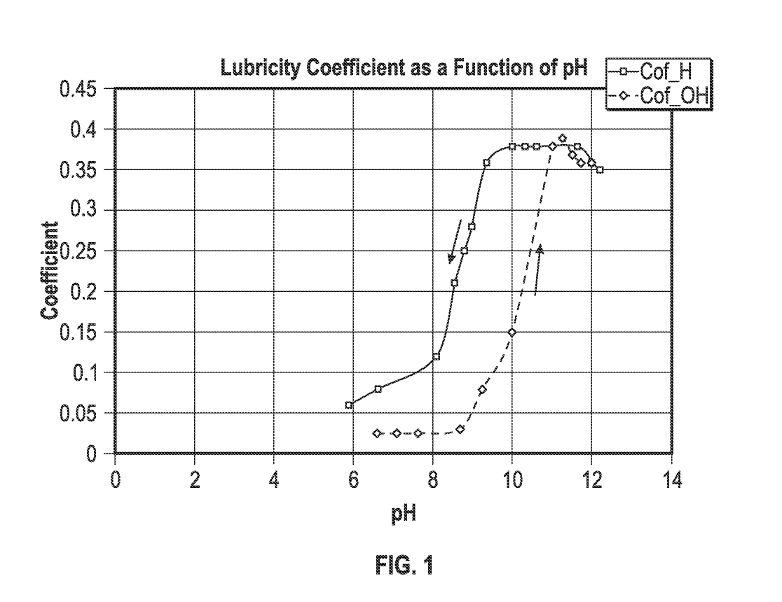

The pH of the fluid for purposes of this disclosure that is considered sufficient to characterize the fluid as a “high pH based drilling fluid” or “high pH based mud” is at least about 7-14 in some embodiments and is 9.0 or higher in other embodiments. A pH range of about 9 to about 13.5 is used in still other embodiments of the invention. The term “high pH mud lubricant” herein refers to a lubricant that provides lubricity to a high pH based drilling fluid. FIG. 1 demonstrates the typical effect of pH on the lubricity coefficient of a simple 20% sodium chloride solution to which approximately 5% alkylsulfide lubricant has been added. The lubricity declines and improves in inverse relation to the increase and decrease in pH. The high pH mud lubricant of the present invention avoids this typical behavior and provides lubricity at high pH.

The high pH mud lubricant of the disclosure is effective in enhancing the lubricity of any high pH aqueous based drilling fluid. Among these are various silicate and siliconate based fluids—silicate, sodium siliconate and potassium siliconate. Polynox™ mud is a commercial brand water-based drilling fluid available from Halliburton in Houston, Tex. and Duncan, Okla. that may be used. Other water based drilling fluid systems that may be used include without limitation lime-Morex systems (“Morex” is a polysaccharaide available from Grain Processing Corp.), other aqueous lime drilling fluid systems, high pH lignosulfonate muds, and gypsum or gyp muds.

The high pH mud lubricant of the present disclosure comprises a mixture or blend of an alcohol and an alkylglucoside or mixture of alkylglucosides. In one embodiment, the alcohol is 2-octyldodecanol. Other alcohols demonstrating low solubility (i.e., approaching little if any solubility) in water and tolerance (i.e., stability) in a base environment may alternatively be used. Such alternative alcohols include oleyl and stearyl alcohols, and selected polyetherglycols such as DOW®LB-1715 and SYNALOX®PB-200, both available from the Dow Chemical Company in Midland, Mich. In one embodiment, the alkylglucoside is 2-ethylhexylglucoside. In another embodiment, the alkylglucoside is a mixture of butyl and hexyl glucosides or an alternative mixture of alkylglucosides having more than about 10 carbon atoms in the alkyl chain (but fewer than about 20 carbon atoms in the alkyl chain). As used herein, the terms “glucoside” and “alkylglucoside” are synonymous with the terms “glycoside” and “alkylglycoside” respectively. Alkylglucosides are available commercially from Seppic in New Jersey and the Societe D'Exploitation de Produits Pour Les Industries Chimiques Seppic, Societe Anonyme, in Paris, France. Examples of suitable commercially available alkylglucosides are Seppic SIMULSOL AS-48™ and Seppic SIMULSOL SL-55™.

In one example embodiment of the lubricant composition, the alcohol in the lubricant is 2-octyldodecanol and the alkylglucosides have between about 4 to about 20 carbon atoms in the alkyl chain. In another example embodiment, the lubricant composition comprises about 80 volume percent 2-octyldodecanol and about 20 volume percent of either 2-ethylhexylglucoside or a mixture of alkylglucosides having between about 10 to about 20 carbon atoms in the alkyl chain.

For the lubricant of the present disclosure to be effective, that is, for the lubricant of the present disclosure to provide lubricity to high pH based muds, the lubricant must be a mixture. The alcohol alone will not provide the desired lubricity; neither will the alkylglucoside alone. Amounts of alcohols in the range of about 90 volume percent to about 40 volume percent and amounts of alkylglucosides in the range of about 10 volume percent to about 60 volume percent are believed to be sufficient quantities to comprise an effective high pH lubricant. In one embodiment, the ratio is about 80 volume percent alcohol to about 20 volume percent alkylglucoside.

Without wishing to be limited by theory, it is presently believed that the alcohol present in the lubricant mixture serves as the more active lubricant and the alkylglucoside present serves primarily as a wetting agent. An advantage of the alkylglucosides is that they are believed to have this wetting capability even in a high pH environment. The lubricant of the present disclosure is advantageously effective in a high pH environment, has low toxicity, and is environmentally acceptable.

The quantity of high pH mud lubricant of the disclosure added to the high pH mud may generally or preferably be in the range of about 4 to about 24 pounds per barrel. The actual amount of lubricant used depends upon operating conditions. In the course of drilling, some amount of lubricant is expected to be lost to drill solids. That is, some lubricant is expected to adsorb onto fresh drill cuttings which will then be separated out of the system by surface solids control equipment. For example, if an inert shale is being drilled with good solids control equipment, a lower level of lubricant, about four to about fourteen pounds per barrel, may typically be used. For another example, if an active, smectite-like shale is being drilled with poor solids control, about fourteen to about twenty-four pounds per barrel lubricant may typically be used.

In one embodiment of the present disclosure, an aqueous drilling fluid is prepared having a high pH, and including the high pH mud lubricant of the disclosure, and is used in drilling a wellbore or borehole in a subterranean formation. The quantity of the lubricant used in the drilling fluid is generally at least about one or two percent by weight of the mud liquid phase. A typical general use rate for the lubricant, for example, might be about one to about five percent by weight based on weight of mud liquid phase present, but this disclosure is not limited to this quantity range. The aqueous base of the fluid is preferably brine, although fresh water and brackish water to water with variable salinity may also be used.

Lubricity tests were conducted using example lubricants of the disclosure in example high pH muds having different weights, with and without drill solids, and having variable temperature exposure. The tests results are discussed below.

### EXPERIMENTS

First to demonstrate the uniqueness of the lubricants of the present disclosure, by contrast with prior art, a simple 20% sodium chloride solution, to which approximately 5% alkylsulfide lubricant such as commonly used in the art was added, was tested for the effects of pH. The results are shown in FIG. 1. As the pH increased, the performance was lost. As the pH was reduced, performance returned. The lubricant was not destroyed by the pH increase to alkaline, but the lubricity effectiveness of the lubricant was significantly reduced. The behavior of this alklylsulfide lubricant at high pH is believed to be typical for commercially available lubricants that are not consistent with the teachings of the present disclosure.

Turning to testing the lubricants of the present disclosure, a silicate mud (containing BARASIL-S™ shale stabilizer in a sodium chloride aqueous base), available from Halliburton Energy Services, Inc. in Houston, Tex. and Duncan, Okla.) was formulated as set forth in Table 1 below with a 13/lb/gal weight. This mud was treated with an example lubricant of the present disclosure, particularly an embodiment wherein the lubricant comprises 80% alcohol and 20% alkylglucoside, and more particularly 80 volume percent 2-octyldodecanol and 20 volume percent of either 2-ethylhexylglucoside. Samples were tested for lubricity and results are reported in Table 1. These results indicate that although this mud had a high, alkaline pH, the lubricant significantly reduced the lubricity coefficient, showing its effectiveness as a lubricant in the mud.

TABLE 1
Aqueous Silicate Drilling Fluid Formulation with Lubricant

| | FORMULATION | | | | | |
|---|---|---|---|---|---|---|
| | A | A | B | B | C | C |
| 20% NaCl Sol, bbl | 0.75 | 0.75 | 0.75 | 0.75 | 0.75 | 0.75 |
| BARASIL-S ™, bbl | 0.10 | 0.10 | 0.10 | 0.10 | 0.10 | 0.10 |
| Silicate shale stabilizer | | | | | | |
| BARAZAN ™ D+, lb | 0.5 | 0.5 | 0.5 | 0.5 | 0.5 | 0.5 |
| Xanthan gum viscosifier | | | | | | |
| PAC ™-L, lb | 1 | 1 | 1 | 1 | 1 | 1 |
| Filtration control agent | | | | | | |
| N-DRILL HT Plus, lb | 4 | 4 | 4 | 4 | 4 | 4 |
| Filtration control agent | | | | | | |
| Barite, lb | 187 | 187 | 187 | 187 | 187 | 187 |
| Rev Dust, lb | 25 | 25 | 25 | 25 | 25 | 25 |
| BARADRINE DEFOAM, lb | 0.3 | 0.3 | 0.3 | 0.3 | 0.3 | 0.3 |
| Blend: 80% 2-octyldodecanol & | 0.00 | 0.00 | 0.03 | 0.03 | 0.00 | 0.00 |
| 20% SILULSOL AS 48 ™ 2-ethylhexyl glucoside, | | | | | | |
| bbl | | | | | | |
| (available from Seppic in France) | | | | | | |
| Blend: 80% 2-octyldodecanol & | 0.00 | 0.00 | 0.00 | 0.00 | 0.03 | 0.03 |
| 20% SILULSOL SL-55 ™ alkylglucoside, bbl | | | | | | |
| (available from Seppic in France) | | | | | | |
| Properties after hot rolling (HR)16 hr at 150° F./ | HR | SA | HR | SA | HR | SA |
| Static Aging (SA)16 hr at 225° F. | | | | | | |
| Temperature ° F. | 120 | 120 | 120 | 120 | 120 | 120 |
| 600 rpm reading | 131 | 80 | 129 | 110 | 127 | 90 |
| 300 rpm reading | 91 | 52 | 87 | 66 | 87 | 57 |
| 200 rpm reading | 75 | 42 | 72 | 52 | 72 | 45 |
| 100 rpm reading | 57 | 29 | 52 | 36 | 52 | 31 |
| 6 rpm reading | 38 | 10 | 20 | 12 | 26 | 11 |
| 3 rpm reading | 38 | 8 | 17 | 10 | 26 | 8 |
| Plastic Viscosity, cp | 40 | 28 | 42 | 44 | 40 | 33 |
| Yield Point, lb/100 ft² | 51 | 24 | 45 | 20 | 47 | 24 |
| 10 sec gel, lb/100 ft² | 20 | 5 | 16 | 5 | 26 | 6 |
| 10 min gel, lb/100 ft² | 33 | 9 | 18 | 8 | 20 | 9 |
| pH | 10.6 | 10.7 | 10.5 | 10.6 | 10.6 | 10.5 |
| Lubricity Coefficient* | 0.17 | 0.24 | 0.07 | 0.09 | 0.07 | 0.07 |
| % reduction in lubricity coefficient | — | — | 59 | 64 | 59 | 71 |
| Shear Strength | — | 667 | — | 345 | — | 320 |
| Lubricity Coefficient (different/repaired meter)* | 0.22 | 0.28 | 0.14 | 0.17 | 0.15 | 0.14 |

*Note: Lubricity is a surface testing type of measurement and there will be variations in the measurements because of this nature of the test itself-the testing of the surface.

Three silicate muds were formulated consistent with the composition set forth in Table 1, except one was unweighted, one was weighted 13.0 lb/gal (as with the mud reported in Table 1), and one was weighted 15.0 lb/gal. To samples of these muds was added a lubricant of the present disclosure, with and without Rev Dust (to simlutate drill cuttings), and exposed to different temperatures (16 hours at 150° F. hot rolling, 16 hours at 250° F. static aging). The lubricant of the invention was a branch-chained alcohol and an alklyl glucoside, particularly 2-octyldodecanol and 2-ethylhexyl glucoside. The lubricity of these samples was measured and the results are reported in Tables 2A, 2B, and 2C. These results indicate that the lubricant of the present disclosure would be effective at different mud weights, even in the presence of drill cuttings, and even after being subjected to different temperatures.

TABLE 2A
Coefficient of Friction (CoF) for Unweighted Silicate Mud

| | | 150° F. | 250° F. |
|---|---|---|---|
| | | Hot Rolling- | Static Aging- |
| | Initial | 16 hrs | 16 hrs |
| Base Mud | 0.23 | 0.25 | 0.27 |
| Base Mud + Lubricant (8 lb/bbl) | 0.14 | 0.10 | 0.14 |
| Base Mud + Rev Dust (25/lb/bbl) | 0.26 | 0.23 | 0.29 |
| Base Mud + Rev Dust + | 0.18 | 0.15 | 0.19 |
| Lubricant | | | |

TABLE 2B
Coefficient of Friction (CoF) for 13.0 lb/gal Silicate Mud

| | | 150° F. | 250° F. |
|---|---|---|---|
| | | Hot Rolling-16 | Static Aging-16 |
| | Initial | hrs | hrs |
| Base Mud | 0.23 | 0.20 | 0.22 |
| Base Mud + Lubricant (8 lb/bbl) | 0.15 | 0.12 | 0.13 |
| Base Mud + Rev Dust (25/lb/bbl) | 0.25 | 0.19 | 0.24 |
| Base Mud + Rev Dust + | 0.17 | 0.16 | 0.13 |
| Lubricant | | | |

TABLE 2C
Coefficient of Friction (CoF) for 15.0 lb/gal Silicate Mud

| | | 150° F. | 250° F. |
|---|---|---|---|
| | | Hot Rolling-16 | Static Aging-16 |
| | Initial | hrs | hrs |
| Base Mud | 0.24 | 0.21 | 0.25 |
| Base Mud + Lubricant (8 lb/bbl) | 0.15 | 0.16 | 0.12 |
| Base Mud + Rev Dust (25/lb/bbl) | 0.24 | 0.20 | 0.31 |
| Base Mud + Rev Dust + | 0.16 | 0.14 | 0.16 |
| Lubricant | | | |

A commercially available silicate mud was obtained and treated with two different embodiments of lubricants of the present disclosure. One lubricant (Lubricant 1) consisted of a blend of a branch-chained alcohol and an alklyl glucoside, particularly 2-octyldodecanol and 2-ethylhexyl glucoside. The other lubricant (Lubricant 2) consisted of a blend of a branch-chained alcohol and a C14-C18 alklyl glucoside. These results indicate that the lubricants of the present disclosure are effective in improving lubricity of a popular commercially available high pH mud without affecting the rheology of the mud.

TABLE 3
Commercially Available Silicate Mud Treated with Lubricants

| | Base Mud | Base + Lubricant 1 | | Base + Lubricant 2 | |
|---|---|---|---|---|---|
| Commercial Silicate Base Mud, bbl | 1.0 | 1.0 | | 1.0 | |
| Lubricant 1, bbl | — | 0.3 | | — | |
| Lubricant 2, bbl | — | — | | 0.3 | |
| Properties initial/hot rolled | — | Initial | HR 150° F. | Initial | HR 150° F. |
| 16 hours at 150° F. | | | | | |
| Temperature ° F. | 120 | 120 | 120 | 120 | 120 |
| 600 rpm reading | 49 | 53 | 51 | 50 | 48 |
| 300 reading | 35 | 38 | 36 | 35 | 34 |
| 200 reading | 23 | 31 | 30 | 29 | 28 |
| 100 reading | 21 | 23 | 23 | 21 | 22 |
| 6 rpm reading | 10 | 15 | 14 | 12 | 12 |
| 3 rpm reading | 9 | 13 | 13 | 11 | 11 |
| Plastic viscosity, cP | 14 | 15 | 15 | 15 | 14 |
| Yield point, lb/100 ft² | 21 | 23 | 21 | 20 | 20 |
| 10 Sec gel, lb/100 ft² | 7 | 7 | 9 | 7 | 7 |
| 10 Min gel, lb/100 ft² | 14 | 17 | 17 | 12 | 14 |
| API fluid loss, ml | 7.6 | — | 4.3 | — | 4.4 |
| pH | 12.0 | 11.3 | 11.3 | 11.3 | 11.2 |
| Lubricity coefficient | 0.38 | 0.15 | 0.19 | 0.14 | 0.15 |

A lime mud, available from Halliburton Energy Services, Inc. in Houston, Tex. and Duncan, Okla.) was formulated using freshwater as set forth in Table 4 below with an example lubricant of the present disclosure, particularly an embodiment wherein the lubricant comprises 80% alcohol and 20% alkylglucoside, and more particularly 80 volume percent 2-octyldodecanol and 20 volume percent of 2-ethylhexylglucoside. Samples were tested for lubricity and results are reported in Table 4. These results indicate that this lubricant in high, alkaline pH mud significantly reduced the lubricity coefficient of the mud, showing the effectiveness of the lubricant in the mud.

TABLE 4
Glucosides in High pH Lime-Freshwater Mud for Lubricity

| | Sample Mark | | | | | | | |
|---|---|---|---|---|---|---|---|---|
| | A | A | B | B | C | C | D | D |
| High pH Mud (POLYNOX)*, bbl | 1.0 | 1.0 | 1.0 | 1.0 | 1.0 | 1.0 | 1.0 | 1.0 |
| Lubricant-80/20 | 0.0 | 0.0 | 3.0 | 3.0 | 0.0 | 0.0 | 3.0 | 3.0 |
| alcohol/alkylglucoside | | | | | | | | |
| Stirred, min | 15 | 15 | 15 | 15 | 15 | 15 | 15 | 15 |
| Rolled at 150° F., hr | 0 | 0 | 0 | 0 | 16 | 0 | 0 | 16 |
| Static Aged at 250° F., hr | — | — | — | — | — | — | — | — |
| Lubricity Coefficient | 0.36 | 0.38 | 0.08 | — | 0.28 | — | 0.08 | 0.03 |

| | | | | |
|---|---|---|---|---|
| Average | 0.37 | — | — | 0.06 |
| Percent Reduction | — | — | — | 83.8 |

*POLYNOX ™ mud in the composition of Table 4 contains 350 ml water, 20 g AQUAGEL ® suspension agent, 40 g Rev Dust, 6 g lime, 2 g caustic soda, 8 g LIGNOX ® PLUS thinner, 0.5 g THERMA-THIN ® additive and 4 g DEXTRID ® stabilized polysaccharide. All of these trademarked products are available from Halliburton Energy Services, Inc. in Houston, Texas and Duncan, Oklahoma.

A lime mud, available from Halliburton Energy Services, Inc. in Houston, Tex. and Duncan, Okla.) was formulated similarly to the mud of Table 4 except that seawater was used instead of freshwater. This mud also included an example lubricant of the present disclosure, particularly an embodiment wherein the lubricant comprises 90% alcohol and 10% C14-C18 alkylglucoside, and more particularly 90 volume percent 2-octyldodecanol and 10 volume percent of 2-ethylhexylglucoside. Samples were tested for lubricity and results are reported in Table 5. These results indicate that this lubricant in high, alkaline pH mud significantly reduced the lubricity coefficient of the mud, showing the effectiveness of the lubricant in the mud.

TABLE 5
Glucosides in High pH Lime-Seawater Mud for Lubricity

| Sample Mark | A | A | B | B |
|---|---|---|---|---|
| High pH Mud (POLYNOX)**, bbl | 1.0 | 1.0 | 1.0 | 1.0 |
| Lubricant-90/10 alcohol/alkylglucoside | 0.0 | 0.0 | 3.0 | 3.0 |
| Stirred, min | 15 | 15 | 15 | 15 |
| Rolled at 150° F., hr | 0 | 16 | 0 | 16 |
| Lubricity Coefficient | 0.47 | 0.42 | 0.28 | 0.31 |

| | | |
|---|---|---|
| Average | 0.45 | 0.26 |
| Percent Reduction | — | 42.2 |

**POLYNOX ™ mud in the composition of Table 5 contains 350 ml seawater, 20 g AQUAGEL ® suspension agent, 40 g Rev Dust, 6 g lime, 2 g caustic soda, 6 g LIGNOX ® PLUS thinner, 0.5 g BARAZAN ® D PLUS additive and 4 g DEXTRID ® stabilized polysaccharide. All of these trademarked products are available from Halliburton Energy Services, Inc. in Houston, Texas and Duncan, Oklahoma.

Tables 6 and 7 set forth example compositions of high pH aqueous based siliconate muds. Those skilled in the art will appreciate that many variations in the composition comprising a high pH based mud (as with any drilling fluid) are possible and may alternatively be used in this disclosure. Untreated siliconates and similar silica drilling fluids or muds typically show lubricity coefficients ranging from about 0.25 to about 0.30 although sometimes 0.35 to 0.50 or to seize.

TABLE 6
Example Aqueous SMS Mud Formula

| | |
|---|---|
| 20% Sodium Chloride solution, bbl | 0.76 |
| Sodium Methyl Siliconate (SMS), bbl | 0.24 |
| XC Polymer, lb | 0-1.0 |
| Sepiolite, lb | 4-14 |
| Fluid Loss Polymer A, lb | 2-3 |
| Fluid Loss Polymer B, lb | 4-8 |
| Rheology Control Polymer, lb | 2-4 |
| BARABRINE DEFOAM, lb | 0.3 |
| BARITE, lb | as needed |
| pH | 12-12.6 |
| Rev Dust, lb | 0-50, for tests |

TABLE 7
Example Aqueous PMS Mud Formula

| | |
|---|---|
| 20% Sodium Chloride solution, bbl | 0.76 |
| Potassium Methyl Siliconate (PMS), bbl | 0.24 |
| XC Polymer, lb | 0-1.5 |
| Sepioliate, lb | 6-14 |
| Fluid Loss Polymer A, lb | 1.5 |
| Fluid Loss Polymer B, lb | 4-8 |
| BARABRINE DEFOAM, lb | 0.3 |
| BARITE, lb | as needed |
| pH | 12-12.6 |
| Rev Dust, lb | 0-50, for tests |

Samples of the muds having the compositions set forth in Tables 6 and 7 were hot rolled for 16 hours at 150° F. and their lubricity measured. For comparison, samples of the muds having the compositions set forth in Tables 6 and 7 were treated with one embodiment of the lubricant of this disclosure, 80 volume percent 2-octyldodecanol and 20 volume percent of either 2-ethylhexylglucoside or a mixture of alkylglucosides having between about 10 to about 20 carbon atoms in the alkyl chain, hot rolled for 16 hours at 150° F. and their lubricity measured. The results of these lubricity measurements are shown in Table 8, again showing significant reduction in lubricity provided by the lubricants of the present disclosure.

TABLE 8
Lubricity Coefficient for Example Aqueous SMS and PMS Muds

| | LUBRICITY |
|---|---|
| MUD WITHOUT LUBRICANT | COEFFICIENT |
| 9.8 lb/gal 20% NaCl/0.24 bbl PMS Mud | 0.29 |
| 13 lb/gal 20% NaCl/0.24 bbl PMS Mud | 0.28 |
| 13 lb/gal 20% NaCl/0.24 bbl SMS Mud | 0.25 |
| MUD TREATED WITH LUBRICANT | LUBRICITY CoF |
| 80% alcohol:20% alkylglucoside | Reduction |
| 9.8 lb/gal 20% NaCl/0.24 bbl PMS Mud | 40% |
| 13 lb/gal 20% NaCl/0.24 bbl PMS Mud | 33% |
| 13 lb/gal 20% NaCl/0.24 bbl SMS Mud | 50% |

Comparison of the mud properties in the various systems in the tables shows that the lubricants of the disclosure did not adversely affect the mud properties. Also, the muds containing the lubricant comprising 2-ethylhexylglucoside, passed the Mysid Shrimp environmental impact test commonly used in the industry. While some other alkylglucosides may not pass the Mysid Shrimp environmental impact test, muds containing such other alkylglucosides are believed environmentally suitable for land use.

As indicated above, the advantages of the methods of the disclosure may be obtained by employing aqueous based drilling fluids of the disclosure in drilling operations. The drilling operations—such as, drilling a vertical, directional or horizontal borehole, conducting a sweep, or running casing and cementing—may be conducted as known to those skilled in the art with other drilling fluids. That is, a drilling fluid or mud of the disclosure is prepared or obtained and circulated through a wellbore as the wellbore is being drilled (or swept or cemented and cased) to facilitate the drilling operation. The drilling fluid removes drill cuttings from the wellbore, cools and lubricates the drill bit, aids in support of the drill pipe and drill bit, and provides a hydrostatic head to maintain the integrity of the wellbore walls and prevent well blowouts. The specific formulation of the drilling fluid in accordance with the present disclosure is optimized for the particular drilling operation and for the particular subterranean formation characteristics and conditions (such as temperatures). For example, the fluid is weighted as appropriate for the formation pressures and thinned as appropriate for the formation temperatures. Further, the fluids of the disclosure may be recycled during a drilling operation such that fluids circulated in a wellbore may be recirculated in the wellbore after returning to the surface for removal of drill cuttings for example.

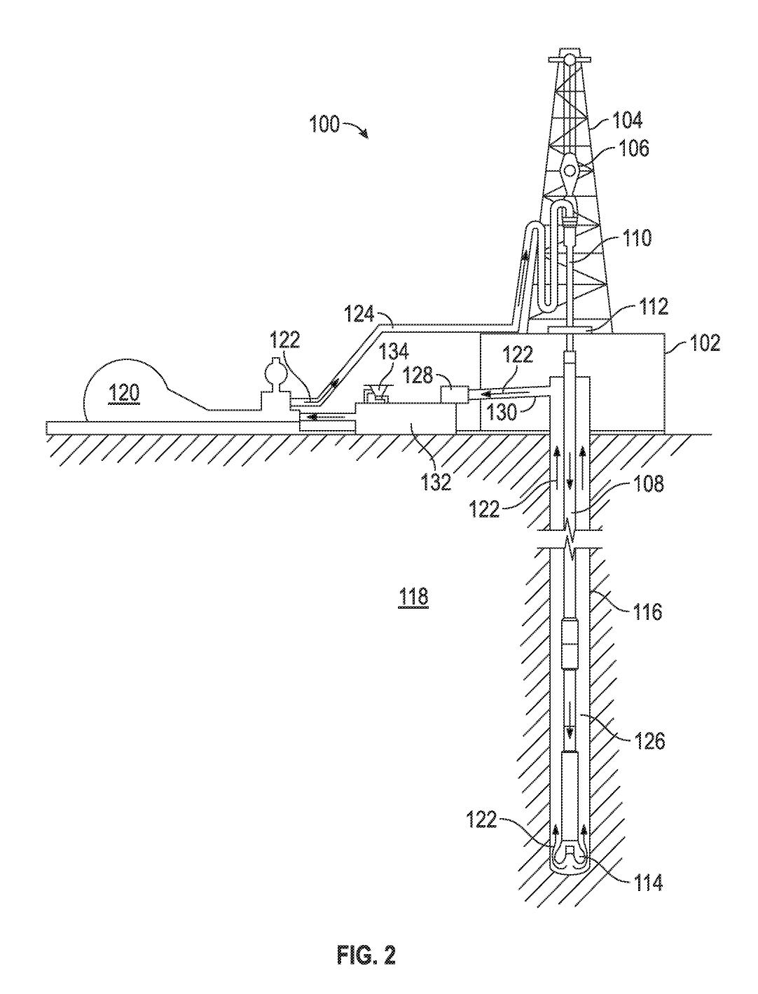

The exemplary lubricants (drilling fluid additives) disclosed herein may directly or indirectly affect one or more components or pieces of equipment associated with the preparation, delivery, recapture, recycling, reuse, and/or disposal of the disclosed additives. For example, and with reference to FIG. 2, the disclosed additives may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed lubricants or lubricant additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed additives may be stored, reconditioned, and/or regulated until added to the drilling fluid 122.

As mentioned above, the disclosed additives may directly or indirectly affect the components and equipment of the drilling assembly 100. For example, the disclosed additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, The fluid processing unit(s) 128 may further include one or more sensors, gauges, pumps, compressors, and the like used store, monitor, regulate, and/or recondition the exemplary additives.

The disclosed additives may directly or indirectly affect the pump 120, which representatively includes any conduits, pipelines, trucks, tubulars, and/or pipes used to fluidically convey the additives downhole, any pumps, compressors, or motors (e.g., topside or downhole) used to drive the additives into motion, any valves or related joints used to regulate the pressure or flow rate of the additives, and any sensors (i.e., pressure, temperature, flow rate, etc.), gauges, and/or combinations thereof, and the like. The disclosed additives may also directly or indirectly affect the mixing hopper 134 and the retention pit 132 and their assorted variations.

The disclosed additives may also directly or indirectly affect the various downhole equipment and tools that may come into contact with the additives such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed additives may also directly or indirectly affect any downhole heat exchangers, valves and corresponding actuation devices, tool seals, packers and other wellbore isolation devices or components, and the like associated with the wellbore 116. The disclosed additives may also directly or indirectly affect the drill bit 114, which may include, but is not limited to, roller cone bits, PDC bits, natural diamond bits, any hole openers, reamers, coring bits, etc.

While not specifically illustrated herein, the disclosed additives may also directly or indirectly affect any transport or delivery equipment used to convey the additives to the drilling assembly 100 such as, for example, any transport vessels, conduits, pipelines, trucks, tubulars, and/or pipes used to fluidically move the additives from one location to another, any pumps, compressors, or motors used to drive the additives into motion, any valves or related joints used to regulate the pressure or flow rate of the additives, and any sensors (i.e., pressure and temperature), gauges, and/or combinations thereof, and the like.

The foregoing description of the disclosure is intended to be a description of some embodiments. Various changes in the details of the described fluids and methods of use can be made without departing from the intended scope of this disclosure as defined by the appended claims. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” “having,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.”

What is claimed is:

1. (canceled)

2. A method for drilling a wellbore in a subterranean formation wherein the method comprises providing or using an aqueous drilling fluid and a high pH lubricant to drill at least a portion of the wellbore, wherein said high pH lubricant comprises low solubility alcohol and alkyglucoside and wherein said alkyglucoside is 2-ethylhexylglucoside or a mixture of butyl and hexyl glucosides.

3. The method of claim 2 wherein said low solubility alcohol is selected from the group consisting of 2-octyldodecanol; polyetherglycols; oleyl alcohols; and stearyl alcohols, and further comprises alkylglucoside selected from the group consisting of 2-ethylhexylglucoside, butyl glucosides, hexyl glucosides, alkylglucosides having more than ten carbon atoms in the alkyl chain, and mixtures thereof.

4. The method of claim 2 wherein said alcohol comprises about 40 to about 90 volume percent of said lubricant.

5. The method of claim 4 wherein said alkylglucoside comprises about 10 to about 60 volume percent of said lubricant.

6. (canceled)

7. (canceled)

8. (canceled)

9. The method of claim 2 wherein said high pH lubricant comprises about 80 volume percent 2-octyldodecanol and about 20 volume percent 2-ethylhexylglucoside.

10. The method of claim 2 wherein said high pH lubricant comprises about 80 volume percent 2-octyldodecanol and about 20 volume percent alkylglucoside mixture wherein said alkylglucosides have greater than about 10 carbon atoms in the alkyl chain.

11. (canceled)

12. A drilling fluid additive comprising about 80 volume percent low solubility alcohol, selected from the group consisting of 2-octyldodecanol; polyetherglycols; oleyl alcohols; and stearyl alcohols, and about 20 volume percent alkylglucoside, selected from the group consisting of 2-ethylhexylglucoside, butyl glucosides, hexyl glucosides, alkylglucosides having greater than about 10 carbon atoms in the alkyl chain, and mixtures thereof, wherein said additive improves the lubricity of said fluid and prevents a noticeable decline in lubricity with an increase in pH.

13. The additive of claim 12 wherein said additive reduces the friction coefficient of said fluid by at least about 20 percent.

14. The additive of claim 12 wherein said additive reduces the friction coefficient of said fluid in the range of about 30 to about 70 percent or more.

15. The additive of claim 12 wherein said additive comprises a mixture of about 80 volume percent 2-octyldodecanol and about 20 volume percent 2-ethylhexylglucoside or about 20 volume percent alkylglucosides having greater than 10 carbon atoms in the alkyl chain.

16. A drilling fluid for use in drilling a wellbore in a subterranean formation wherein said drilling fluid comprises a high pH mud base, sodium chloride, and a high pH mud lubricant wherein said high pH mud lubricant comprises 2-octyldodecanol and an alkylglucoside or alkylglucoside mixture selected from the group consisting of 2-ethylhexylglucoside, butyl glucosides, hexyl glucosides, alkylglucosides having greater than about 10 carbon atoms in the alkyl chain, and mixtures thereof.

17. The drilling fluid of claim 16 wherein said lubricant comprises about 80 volume percent 2-octyldodecanol and about 20 volume percent of 2-ethylhexylglucoside or a mixture of butyl glucosides and hexyl glucosides or a mixture of alkylglucosides having greater than about 10 carbon atoms in the alkyl chain.

18. The drilling fluid of claim 17 wherein the lubricity coefficient of said fluid is less than or equal to about 0.2.

19. The drilling fluid of claim 18 wherein the lubricity coefficient of said fluid is less than or about equal to about 0.26.

20. The drilling fluid of claim 16 wherein said high pH mud lubricant comprises about 40 to about 90 volume percent 2-octyldodecanol and about 10 to about 60 volume percent alkylglucoside mixture wherein said alkylglucosides have at least about 10 carbon atoms in the alkyl chain.

21. The drilling fluid of claim 20 wherein said lubricant comprises about 90 volume percent 2-octyldodecanol and about 10 volume percent alkylglucoside mixture.

22. The drilling fluid of claim 20 wherein the lubricity coefficient of said fluid is less than or equal to about 0.2.

23. The drilling fluid of claim 22 wherein the lubricity coefficient of said fluid is less than or about equal to about 0.26.
